(19) United States
(12) Patent Application Publication
(10) Pub. No.: US 2009/0308051 A1
(43) Pub. Date: Dec. 17, 2009

(54) HEAT EXCHANGER TUBE AND AIR-TO-AIR INTERCOOLER

(75) Inventors: Russ L. Henderson, Springfield, MO (US); Christopher B. Jungers, Tulsa, OK (US)

Correspondence Address: GABLE & GOTWALS, 100 WEST FIFTH STREET, 10TH FLOOR, TULSA, OK, 74103, US

(73) Assignee: GEA Rainey Corporation

(21) Appl. No.: 12/137,037

(22) Filed: Jun. 11, 2008

(51) Int. Cl. F02K 99/00; F28D 7/10

(52) U.S. Cl. 60/267; 165/154

(57) ABSTRACT

An improved heat exchanger tube which can be used in an air-to-air intercooler or other air-to-air heat exchangers. The cooling tube has a first tube with an inner and outer surface and a second tube with an inner and outer surface. The second tube is located inside the first tube. There are one or more walls extending from the inner surface of the first tube to the outer surface of the second tube. A plurality of fins are located on the outer surface of the first tube. The fins can take the form of individual circular fins or one or more helical fins.

### 1. FIELD OF THE INVENTION

The present invention relates generally to an air-to-air intercooler for a gas turbine. More particularly, the present invention relates to an improved tube for use in an air-to-air intercooler.

### 2. BACKGROUND OF THE INVENTION

Use of gas turbines has become commonplace in industry today. Gas turbines used to drive electrical generators have become particularly commonplace. A gas turbine fired electrical generating plant can be erected in a fraction of the time necessary to build a coal fired or nuclear power plant and at a fraction of the cost. They also have an advantage over other sources of electricity, such as hydroelectric and wind generation in that they can be located essentially anywhere. The gas turbine compresses air. The compression greatly increases the temperature of the air. The air is then mixed with fuel and combusted. The forces generated from this combustion are used to rotate the turbine. In order to reduce emissions of various pollutants and to increase turbine efficiency, an intercooler is used to cool the compressed air prior to second stage compression.

The prior art cooling systems for a gas turbine include an intercooler and a secondary cooler. The intercooler is typically a shell and tube type heat exchanger. The hot compressed air pulled from the gas turbine is circulated through the shell side of the heat exchanger. Cool water from a secondary cooler is circulated through the tubes of the heat exchanger. Heat from the hot air and gases is transferred to the cooling water. The cooled compressed air is then recirculated to the gas turbine where it is introduced to the second stage compressor, and ultimately mixed with fuel and combusted. The secondary cooler is typically a fin type heat exchanger. The water which has been heated in the intercooler is circulated through a plurality of tubes in the secondary cooler. One or more fans create a draft of ambient air across the outside of the tubes. This causes heat from the water to be transferred to the ambient air. The cooled water is then recirculated through the intercooler to cool the hot compressed air from the turbine. This is currently the most feasible solution.

The ideal solution for reducing the amount of equipment and maintenance necessary for a gas turbine would be to cool it directly using an air-to-air intercooler, but a significant challenge is that air cannot carry as much heat as water. As such it would take an extremely large air-to-air intercooler to dissipate the amount of heat created in a gas turbine. The air-to-air heat exchangers currently available cannot provide sufficient surface area in a compact unit to make this option plausible, as the internal volume of an intercooler using conventional tubes is too large and presents a risk to the turbine during shutdown.

What is needed in the gas turbine and heat exchanger industry is an air-to-air heat exchanger which can provide sufficient surface area in a compact package to cool the combustion air of a gas turbine.

Further what is needed in the gas turbine industry and heat exchanger industry is an air-to-air intercooler which is capable of cooling the gas turbine without use of a secondary cooler.

### BRIEF SUMMARY OF THE INVENTION

The present invention is an improved cooling tube which can be used in an air-to-air intercooler or other air-to-air heat exchangers. The cooling tube is comprised of two nested circles joined together via flat metal strips formed during extrusion. A plurality of fins are located on the outer surface of the first tube. The fins can take the form of individual circular fins or one or more helical fins.

The improved cooling tube provides sufficient surface area to act as an intercooler for a gas turbine without use of a secondary cooler. Further embodiments of the present invention provide for a gas turbine system wherein the tube design is used in an air-to-air intercooler.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawings (which are not to scale) where:

FIG. 1 is a schematic of a prior art gas turbine system using an intercooler and secondary cooler.

FIG. 2 is a perspective view of a gas turbine and the air-to-air intercooler using the improved cooling tube of the present invention.

FIG. 3 is a perspective sectional view of the improved cooling tube.

FIG. 4 is a cross-sectional end view of the improved cooling tube.

FIG. 5 is a schematic illustrating the present invention incorporated in an A-frame design forced draft intercooler.

FIG. 6 is a schematic illustrating the present invention incorporated in a V-frame design induced draft intercooler.

FIG. 7 is a schematic illustrating the present invention in use with a U-frame design induced draft intercooler.

FIG. 8 is a schematic view of the present invention incorporated in a U-frame design forced draft intercooler.

### DETAILED DESCRIPTION OF THE PREFERRED EMBODIMENT(S)

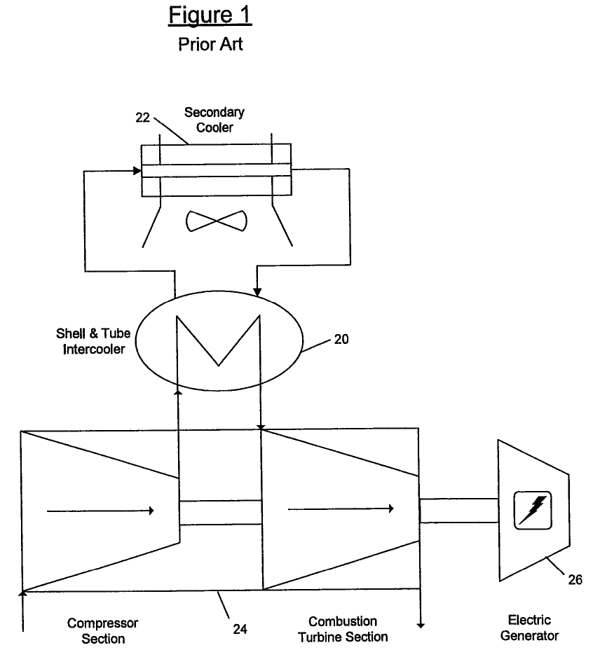

Turning now to the drawings wherein like reference characters indicate like or similar parts throughout, FIG. 1 illustrates a prior art system wherein an intercooler 20 and secondary cooler 22 are used to cool the compressed combustion air for a gas turbine 24. The gas turbine 24 is typically used to run an electrical generator 26. Hot compressed air from the gas turbine 24 are circulated through the intercooler 20. The intercooler 20 is typically a shell and tube heat exchanger. The hot compressed air flows through the shell side of the intercooler 20. The tubes of the intercooler carries water which has been cooled by the secondary cooler 22. The heat from the hot compressed air is transferred into the water. The cooled compressed air is transferred back to the gas turbine where it is introduced to the second stage compressor and ultimately mixed with fuel and combusted.

After the cooled water absorbs heat in the intercooler it is pumped back to the secondary cooler 22. The secondary cooler 22 is typically a fin fan water-to-air cooler wherein the warm water passes through a plurality of tubes in the secondary cooler 22. Fans are then used to create a flow of ambient air across these tubes thus cooling the water carried in the tubes and transferring it to the ambient air. Once the water has been cooled in the secondary cooler 22 it is pumped back to the intercooler 20 where the cycle is repeated.

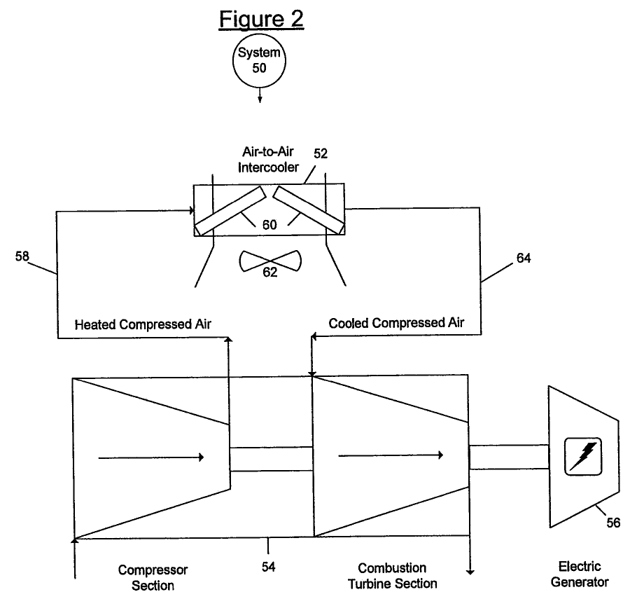

Turning now to FIG. 2 the gas turbine system 50 of the present invention uses an air-to-air cooler 52 as an intercooler for a gas turbine 54 powering a generator 56. Hot compressed air is pulled from the gas turbine outlet 58 and transferred to the cooler 52. The hot compressed air passes through a plurality of tubes 60. As the hot compressed air passes through the tubes one or more fans 62 create a flow of ambient air across the outside of the tubes 60. Heat from the hot compressed air in the tubes 60 is transferred to the ambient air thus cooling the hot compressed air. Once the hot compressed air has been cooled it is transferred back to the gas turbine inlet 64. The cooled compressed air mixed with fuel and combusted.

In order to have sufficient surface area inside the tubes 60 to transfer heat from the hot compressed air it is necessary to use the improved tubes 60 of the present invention.

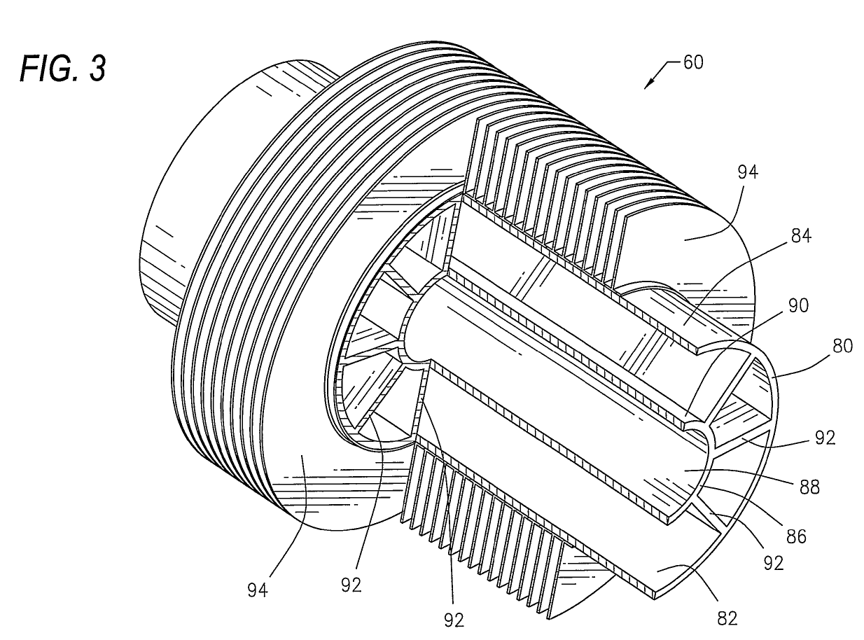

As seen in FIG. 3, the improved tube 60 is comprised of a first tube 80 having an inner surface 82 and an outer surface 84. The cooling tube 60 has a second tube 86 located inside the first tube 80. In some embodiments the first and second tubes 80 and 86 can be concentric.

The second tube 86 has an inner surface 88 and an outer surface 90. One or more walls 92 extend from the inner surface 82 of the first tube 80 to the outer surface 90 of the second tube 86. One or more fins 94 are located on the outer surface 84 of the first tube 80. FIGS. 3 and 4 show the fins 94 comprised of a plurality of individual circular shaped fins. However, it is possible to construct the present invention using one or more continuous helical fins 94 located on the outer surface 84 of the first tube 80.

FIGS. 3 and 4 illustrate the present invention using eight (8) walls 92. However the exact number of walls 92 as well as their thickness and the diameter and wall thickness of the first and second tubes 80 and 86 as well as the exact geometry and number of the fins 94 are determined as a function of the heat transfer properties of the metal used to construct these parts as well as the temperature of the hot compressed air being cooled inside the tubes and the expected temperature of the ambient air flowing across the fins 94.

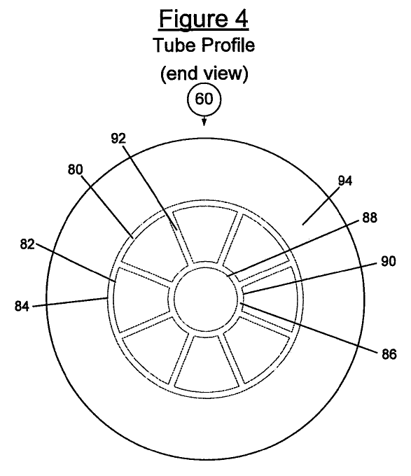

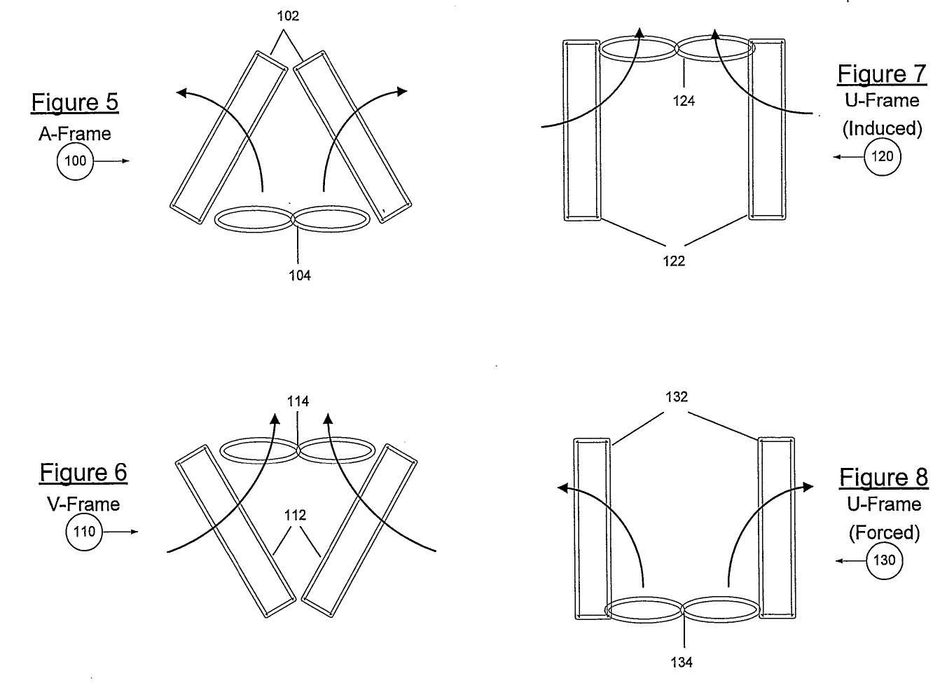

The present invention can be incorporated into various configurations of coolers. FIG. 5 illustrates an A-frame design using a forced draft 100 wherein the opposing tube bundles 102 are angled towards each other forming an A-frame. One or more fans 104 then force the ambient air upward and through the tube bundles 102 as indicated by the arrows.

FIG. 6 illustrates a V-frame design 110 wherein opposing tube bundles 112 are angled together forming a V-shape. One or more fans 114 are used to pull the ambient air through the tube bundles 112 in the pattern indicated by the arrows.

The present system can also utilize a U-frame design 120 with an induced draft as illustrated in FIG. 7. Here opposing tube bundles 122 are located parallel to one another. One or more fans 124 are then used to induce a draft of ambient air across the tube bundles as indicated by the arrows.

The present invention can also incorporate a U-frame design 130 using a forced draft configuration as seen in FIG. 8. Here opposing tube bundles 132 are located parallel to one another. One or more fans 134 are then used to force the draft of ambient air across the tube bundles 132 as indicated by the arrows.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A heat exchanger tube comprising:
a first tube having an inner surface and an outer surface; and
a second tube having an inner surface and an outer surface, said second tube located inside said first tube.

2. A heat exchanger tube according to claim 1, further comprising one or more walls extending from said inner surface of said first tube to said outer surface of said second tube.

3. A heat exchanger tube according to claim 1, further comprising a fin extending from said outer surface of said first tube.

4. A heat exchanger tube according to claim 3, said fin comprising a helical coil.

5. A heat exchanger tube according to claim 1, further comprising a plurality of fins extending from said outer surface of said first tube.

6. A heat exchanger tube according to claim 1, further comprising said first and second tubes being concentric.

7. An electrical generating system comprising:
a turbine;
an air-to-air intercooler having a first tube with an inner surface and an outer surface, a second tube having an inner surface and an outer surface, said second tub located inside said first tube;
wherein said first and second tube are in fluid communication with said gas turbine.

8. A system according to claim 7, further comprising one or more walls extending from said inner surface of said first tube to said outer surface of said second tube.

9. A system according to claim 7, further comprising a fin extending from said outer surface of said first tube.

10. A system according to claim 9, said fin comprising a helical coil.

11. A system according to claim 7, further comprising a plurality of fins extending from said outer surface of said first tube.

12. A system according to claim 7, further comprising said first and second tubes being concentric.

13. A system according to claim 7, said first and second tubes comprising a plurality of first and second tube runs.

14. A system according to claim 7, further comprising a fan located to induce a draft of ambient air across said tubes.

15. A system according to claim 7, further comprising a fan located to force a draft of ambient air across said tubes.
